(19) United States
(12) Patent Application Publication
(10) Pub. No.: US 2005/0157491 A1
(43) Pub. Date: Jul. 21, 2005

(54) Foldable lamp shade device

(76) Inventor: Ting-Sheng Li, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/764,298

(22) Filed: Jan. 20, 2004

(51) Int. Cl. F21V 1/00

(52) U.S. Cl. 362/162

(57) ABSTRACT

A foldable lamp shade device includes a housing, a lining mounted in the housing, and a plurality of fixing members mounted between the housing and the lining to combine the housing and the lining together. Thus, the foldable lamp shade device is mounted and detached easily, rapidly and conveniently, thereby facilitating the user assembling and disassembling the lamp shade device. In addition, the lamp shade device can be folded when not in use, thereby greatly saving the cost, space and time of package, storage and transportation.

### BACKGROUND OF THE INVENTION

1. Field of the Invention

The present invention relates to a foldable lamp shade device, and more particularly to a lamp shade device that is mounted and detached easily and conveniently, thereby facilitating the user assembling and disassembling the lamp shade device.

2. Description of the Related Art

A conventional lamp shade comprises a housing, and a lining mounted in the housing. The housing includes a shade body, a first support ring mounted on a first portion of the shade body, a second support ring mounted on a second portion of the shade body, and an elastic snap soldered on the first support ring. The lining has an upper portion snapped onto the elastic snap of the first support ring of the housing and a lower portion bonded on the second support ring of the housing, so that the housing is combined with the lining.

However, the elastic snap is easily worn out during a long-term utilization, thereby decreasing the lifetime of the conventional lamp shade. In addition, the conventional lamp shade cannot be folded when not in use, thereby greatly increasing the cost, space and time of package, storage and transportation. Further, the conventional lamp shade is not mounted and detached easily and conveniently, thereby causing inconvenience to the user when assembling and disassembling the lamp shade device.

### SUMMARY OF THE INVENTION

The primary objective of the present invention is to provide a foldable lamp shade device that is mounted and detached easily, rapidly and conveniently, thereby facilitating the user assembling and disassembling the lamp shade device.

Another objective of the present invention is to provide a lamp shade device that can be folded when not in use, thereby greatly saving the cost, space and time of package, storage and transportation.

A further objective of the present invention is to provide a lamp shade device that is mounted and detached rapidly, thereby decreasing the time and cost of mounting the lamp shade device.

In accordance with the present invention, there is provided a lamp shade device, comprising a housing, and a lining mounted in the housing, wherein:
the housing includes a shade body, a first support ring mounted on a first portion of the shade body, a second support ring mounted on a second portion of the shade body, a support frame mounted in the first support ring, and a plurality of support rods detachably mounted between the first support ring and the second support ring; and
the lining includes a lining body mounted in the shade body, a first ring mounted on a first portion of the lining body and rested on the first support ring of the housing, a second ring mounted on a second portion of the lining body and rested on the second support ring of the housing, and a plurality of support bars mounted on the first ring and rested on the support frame of the housing.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a lamp shade device in accordance with the preferred embodiment of the present invention;

FIG. 2 is an exploded perspective view of the lamp shade device as shown in FIG. 1;

FIG. 3 is a partially cut-away perspective cross-sectional view of the lamp shade device as shown in FIG. 1;

FIG. 4 is a partially cut-away plan exploded view of the lamp shade device as shown in FIG. 3;

FIG. 5 is a perspective view of a lining of the lamp shade device as shown in FIG. 1;

FIG. 6 is a bottom plan view of the lamp shade device as shown in FIG. 1; and

FIG. 7 is a partially cut-away plan view of the lamp shade device as shown in FIG. 1.

### DETAILED DESCRIPTION OF THE INVENTION

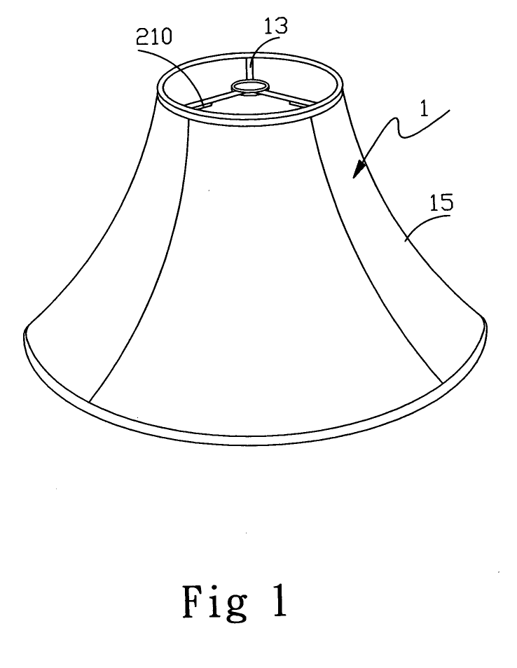

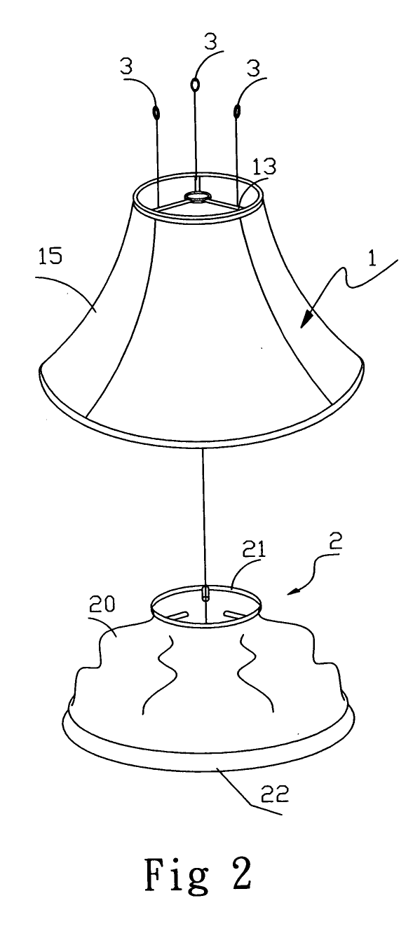

Referring to the drawings and initially to FIGS. 1 and 2, a foldable lamp shade device in accordance with the preferred embodiment of the present invention comprises a housing 1, a lining 2 mounted in the housing 1, and a plurality of fixing members 3 mounted between the housing 1 and the lining 2 to combine the housing 1 and the lining 2 together.

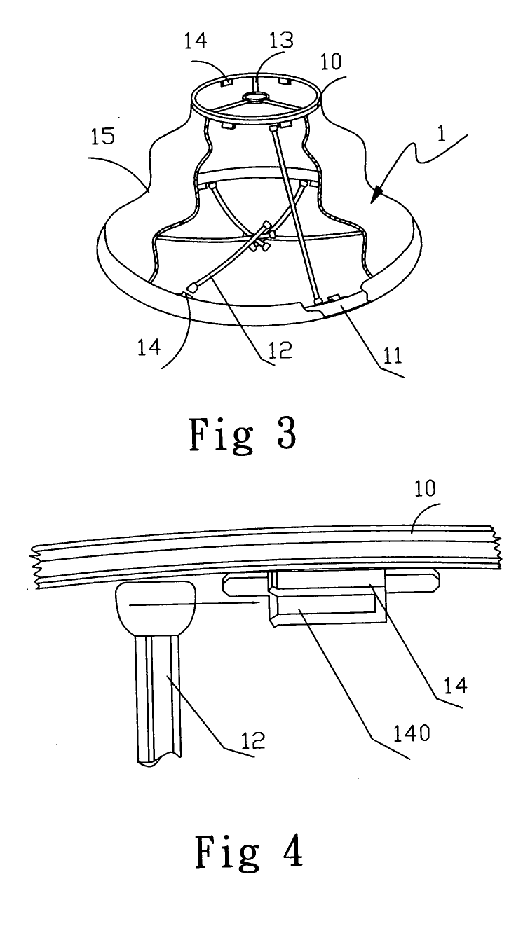

Referring to FIGS. 1-4, the housing 1 includes a shade body 15, a first support ring 10 mounted on a first portion of the shade body 15, a second support ring 11 mounted on a second portion of the shade body 15, a radially extended support frame 13 mounted in the first support ring 10, and a plurality of support rods 12 detachably mounted between the first support ring 10 and the second support ring 11.

Each of the first support ring 10 and the second support ring 11 is provided with a plurality of locking flanges 14, and each of the support rods 12 has two ends each detachably mounted on a respective one of the locking flanges 14. Each of the locking flanges 14 is formed with a locking groove 140, and each of the two ends of each of the support rods 12 is detachably locked in the locking groove 140 of a respective one of the locking flanges 14.

In addition, the locking flanges 14 of the first support ring 10 and the locking flanges 14 of the second support ring 11 are directed toward different directions.

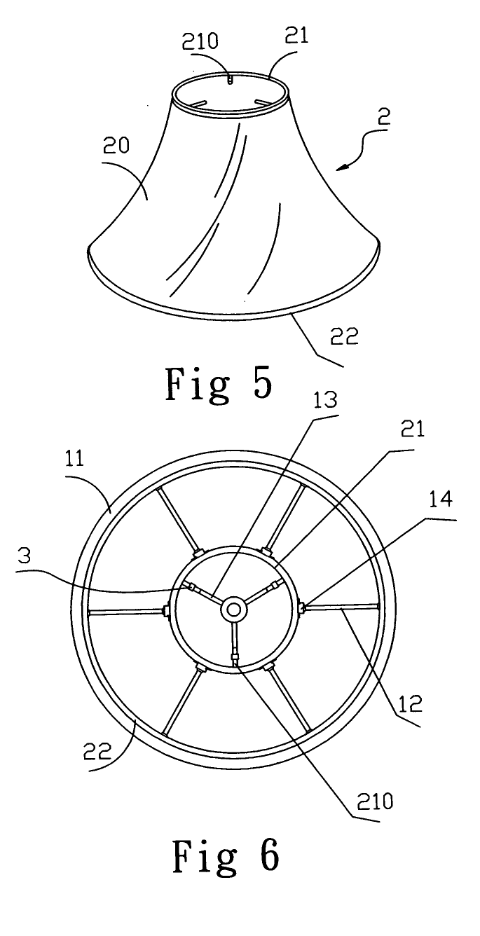

Referring to FIGS. 1-6, the lining 2 includes a lining body 20 made of a soft cloth mounted in the shade body 15, a first ring 21 mounted on a first portion of the lining body 20 and rested on the first support ring 10 of the housing 1, a second ring 22 mounted on a second portion of the lining body 20 and rested on the second support ring 11 of the housing 1, and a plurality of support bars 210 mounted on the first ring 21 and rested on the support frame 13 of the housing 1. Preferably, the support bars 210 of the lining 2 are arranged in a radially manner, and are radially extended inward from the first ring 2 1.

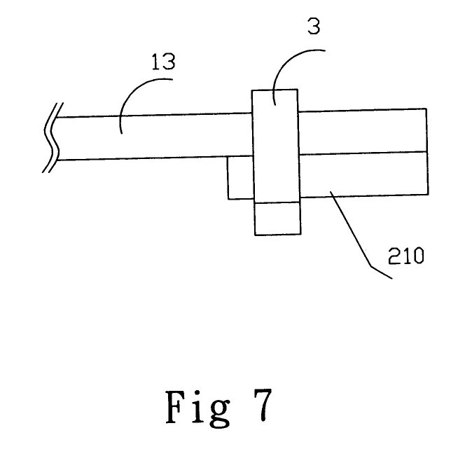

Referring to FIGS. 1-7, each of the fixing members 3 is mounted on the support frame 13 of the housing 1, and each of the support bars 210 of the lining 2 is detachably inserted into a respective one of the fixing members 3 and urged on the support frame 13 of the housing 1, so that the first support ring 10 of the housing 1 and the first ring 21 of the lining 2 are combined together, and the housing 1 and the lining 2 are combined together.

When not in use, each of the support bars 210 of the lining 2 is detached from a respective one of the fixing members 3, so that the lining 2 is detached from the housing 1 and can be folded. Then, each of the support rods 12 is detached from the locking groove 140 of a respective one of the locking flanges 14, so that the housing 1 can be folded.

Accordingly, the foldable lamp shade device can be folded when not in use, thereby greatly saving the cost, space and time of package, storage and transportation. In addition, the foldable lamp shade device is mounted and detached easily, conveniently, thereby facilitating the user assembling and disassembling the lamp shade device. Further, the foldable lamp shade device is mounted and detached rapidly, thereby decreasing the time and cost of mounting the lamp shade device.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp shade device, comprising a housing, and a lining mounted in the housing, wherein:
the housing includes a shade body, a first support ring mounted on a first portion of the shade body, a second support ring mounted on a second portion of the shade body, a support frame mounted in the first support ring, and a plurality of support rods detachably mounted between the first support ring and the second support ring; and
the lining includes a lining body mounted in the shade body, a first ring mounted on a first portion of the lining body and rested on the first support ring of the housing, a second ring mounted on a second portion of the lining body and rested on the second support ring of the housing, and a plurality of support bars mounted on the first ring and rested on the support frame of the housing.

2. The lamp shade device in accordance with claim 1, wherein each of the first support ring and the second support ring is provided with a plurality of locking flanges, and each of the support rods has two ends each detachably mounted on a respective one of the locking flanges.

3. The lamp shade device in accordance with claim 2, wherein each of the locking flanges is formed with a locking groove, and each of the two ends of each of the support rods is detachably locked in the locking groove of a respective one of the locking flanges.

4. The lamp shade device in accordance with claim 2, wherein the locking flanges of the first support ring and the locking flanges of the second support ring are directed toward different directions.

5. The lamp shade device in accordance with claim 1, wherein the support frame of the housing is radially extended.

6. The lamp shade device in accordance with claim 1, wherein the lining body is made of a soft cloth.

7. The lamp shade device in accordance with claim 1, wherein the support bars of the lining are arranged in a radially manner.

8. The lamp shade device in accordance with claim 1, wherein the support bars of the lining are radially extended inward from the first ring.

9. The lamp shade device in accordance with claim 1, further comprising a plurality of fixing members mounted between the housing and the lining to combine the housing and the lining together.

10. The lamp shade device in accordance with claim 9, wherein each of the fixing members is mounted on the support frame of the housing, and each of the support bars of the lining is detachably inserted into a respective one of the fixing members and urged on the support frame of the housing, so that the first support ring of the housing and the first ring of the lining are combined together, and the housing and the lining are combined together.
